(19) United States
(12) Patent Application Publication
(10) Pub. No.: US 2007/0245646 A1
(43) Pub. Date: Oct. 25, 2007

(54) MULTIPLE-GLAZING UNIT AND METHOD FOR MANUFACTURING THE SAME

(75) Inventors: Takayoshi SAITO, Yokohama-shi (JP); Teruo Matsuyama, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 11/754,017

(22) Filed: May 25, 2007

Related U.S. Application Data
(63) Continuation of application No. PCT/JP05/21716, filed on Nov. 25, 2005.

(30) Foreign Application Priority Data
Nov. 26, 2004 (JP) 2004-341875

(51) Int. Cl. E06B 7/12

(52) U.S. Cl. 52/172

(57) ABSTRACT

A multiple-glazing unit capable of reliably maintaining the gap between adjacent glass sheets thereof without impairing its appearance is provided.

In a multiple-glazing unit 10 according to the present invention, a gap-maintaining member 20 for maintaining the gap between two facing glass sheets 12 is fitted in a space 18 formed in a concave shape in section by an outer peripheral surface of a resin spacer 16 and the inner sides of peripheral portions of the two facing glass sheets 12. The gap-maintaining member 20 is disposed such that its outer side face 20A is flush with peripheral edges 12A of the two glass sheets 12 or is slightly closer to an air space 14 than the peripheral edges. The gap-maintaining member 20 comprises a hard portion 22 formed in a concave shape in section so as to be inserted into the space between the glass sheets 12, and soft portions 24 which are provided on the hard portion 22 at locations where the hard portion 22 faces the glass sheets 12, which are brought into contact with the inner surfaces of the peripheral portions of the glass sheets 12, and which are softer than the hard portion. The soft portions 24 are configured such that it is easy to insert the hard portion 22 into the space 18 while making it unlikely that the hard portion 22 comes out.

### TECHNICAL FIELD

The present invention relates to a multiple-glazing unit, and more particularly, to a multiple-glazing unit manufactured by using a self-adhesive resin spacer and to a method for manufacturing the same.

### BACKGROUND ART

There have been known multiple-glazing units, which usually have two glass sheets facing each other through a spacer with a desiccant sealed therein and have an air space formed between the two glass sheets. Multiple-glazing units are mainly used for buildings and vehicles. Multiple-glazing units are configured such that a primary seal made of a butyl sealing material and so forth is cast between an aluminum spacer and the two glass sheets to block outside air from entering the air space, and a secondary seal made of an elastic sealing material and so forth is cast in a space formed in a concave shape in section by inner surfaces of peripheral portions of the two facing glass sheets and an outer peripheral surface of the spacer.

When multiple-glazing units using a metal spacer are manufactured, however, since there are many manufacturing steps, such as a step for cutting metal spacers according to the size of glass sheets, a bending step, and a step for bonding to glass sheets, it is necessary to provide a large-scale facility from the outset. It has been difficult to manufacture multiple-glazing units in a simple facility.

Therefore, it has been proposed (in patent document 1, for example) that resin spacers be used instead of metal spacers in order to allow multiple-glazing units to be manufactured in a simple facility. Resin spacers are easier to cut, bend, and bond than metal spacers and provide improved thermal insulation at a peripheral portion of the multiple-glazing units, compared with metal spacers. Therefore, resin spacers have attracted attention.

However, multiple-glazing units with resin spacers have a problem in that resin spacers are likely to be deformed because of being less rigid than metal spacers. The multiple-glazing unit according to patent document 2 solves this problem.

In the multiple-glazing unit according to patent document 2, protrusions 4 of a spacer piece 3, which have a cross-sectional shape like supports of a Japanese wooden clog, are embedded in a heat-softened thermoplastic resin spacer 2 from an outer peripheral surface side of the thermoplastic resin spacer 2, which bonds two glass sheets, as shown in FIG. 7. With this arrangement, the gap between the two glass sheets 1 is maintained by the protrusions 4, and the thermoplastic resin spacer 2 is hardened to bond and secure the spacer piece 3 and the two glass sheets 1 to prevent the multiple-glazing unit from being deformed. Reference numeral 5 indicates an air space formed between the two glass sheets 1.

Patent document 1: JP-A-6-123191

Patent document 2: JP-A-11-130475

### DISCLOSURE OF THE INVENTION

### Problems to be Solved by the Invention

A general multiple-glazing unit is fitted in a rectangular groove 7 of an attachment member 6, as shown in FIG. 8, at a peripheral edge thereof, and the multiple-glazing unit is mounted to a sash (not shown) by using the attachment member 6.

The depth L of the rectangular groove 7 of the attachment member 6 is designed to match the position of a face 2A of the resin spacer 2 facing the air space; the amount of the resin spacer 2 to be cast is specified according to the size of the glass sheets and so forth. The reason therefor is to prevent the resin spacer 2, which is usually black, from being viewed from the outside by using the attachment member 6 serving as decorative plates, from a design point of view. If the depth L of the rectangular groove 7 is extended to make the resin spacer 2 completely unseen from the outside, the attachment member 6 becomes large to make the area of the glass sheets smaller, thus deteriorating the appearance thereof when serving as a window. FIG. 8 shows, as an example, a multiple-glazing unit in which only the resin spacer 2 is cast without providing the spacer piece 3 (see FIG. 7).

When the multiple-glazing unit according to patent document 2 is viewed from a design point of view, the face 2A of the resin spacer 2 facing the air space protrudes from the attachment member 6 by the thickness “t” of the spacer piece 3 toward the inner side as shown in FIG. 9, deteriorating the appearance. If the depth L of the rectangular groove 7 is extended by “t” to cope with this problem, the attachment member 6 becomes large to make the area of the glass sheets smaller, thus deteriorating the appearance thereof when serving as a window.

In addition, since the multiple-glazing unit according to patent document 2 is constructed such that the protrusions 4 of the spacer piece 3 are just embedded into the thermoplastic resin spacer 2, the spacer piece 3 has easily come off in some cases until the resin spacer 2 is dried and hardened.

The present invention has been proposed in view of the foregoing circumstances. It is an object of the present invention to provide a multiple-glazing unit capable of reliably maintaining the gap between glass sheets without impairing its appearance, by using a gap-maintaining member for maintaining the thickness of an air space of the multiple-glazing unit, in particular, a self-adhesive resin spacer, and to provide a method for manufacturing the same.

### Means for Solving the Problems

To achieve the foregoing object, the present invention provides a multiple-glazing unit in which a resin spacer is placed close to peripheral edges of at least two facing glass sheets to separate the glass sheets with a gap therebetween to form an air space therebetween, wherein a gap-maintaining member for maintaining the gap between the two glass sheets is fitted in a space formed in a concave shape in section by inner surfaces of peripheral portions of the two facing glass sheets and an outer peripheral surface of the resin spacer, and the gap-maintaining member is placed flush with the peripheral edges of the two glass sheets or closer to the air space than the peripheral edges.

According to the multiple-glazing unit described above, the gap-maintaining member is fitted in the space formed in a concave shape in section by the inner surfaces of the peripheral portions of the two facing glass sheets and the outer peripheral surface of the resin spacer, and the gap-maintaining member is placed flush with the peripheral edges of the two glass sheets or closer to the air space than the peripheral edges. Therefore, the resin spacer does not protrude from an attachment member, and therefore does not impair the appearance of the multiple-glazing unit. Since the gap-maintaining member is fitted in the space formed in a concave shape in section, the gap between the glass sheets can be reliably maintained. The gap-maintaining member does not need to be disposed around the entire periphery of the multiple-glazing unit. For example, the gap-maintaining member may comprise plural members formed in a block shape having several cm, so that they can be disposed at predetermined intervals or at predetermined positions to maintain the gap between the glass sheets.

According to the present invention, in the multiple-glazing unit, the gap-maintaining member may comprise a hard portion to be inserted into the space between the glass sheets, and a soft portion, which is provided on the hard portion, which is brought into close contact glass surfaces of the glass sheets, and which is softer than the hard portion.

According to the present invention, in the multiple-glazing unit, the soft portion of the gap-maintaining member may comprise (1) a fin-shaped member tilted at an acute angle with respect to an insertion direction of the hard portion; (2) a dome-shaped member having an apex at a position where the dome-shaped member is brought into contact with a glass surface of the glass sheets, and having a space formed between the dome-shaped member and the hard portion, or within the dome-shaped member; or a wave-shaped member.

When the hard portion is inserted into the space, the soft portion makes the insertion of the hard portion easy. After insertion, the soft portion offers resistance in a direction in which the hard portion comes out. In the gap-maintaining member having the fin-shaped soft portion at a position where the hard portion, serving as a core, faces a glass sheet, a fin is tilted at an acute angle with respect to the direction in which the hard portion is inserted to make the insertion easy, and the fin serves as a barb, so that the hard portion does not come out after being inserted. In the gap-maintaining member having the soft portion which comprises a dome-shaped member, the dome-shaped soft portion having an apex at a position, where the hard portion, serving as a core, faces a glass sheet, is brought into contact with the glass sheet to crush a formed hollow portion therein, with the result that the hard portion can be easily inserted between the glass sheets. After insertion, since the soft portion and the relevant glass sheet are brought into surface contact with each other, a large friction resistance is generated, so that the hard portion is unlikely to come out. In the same way, even in the gap-maintaining member having the soft portion which comprises a wave-shaped member, the hard portion is unlikely to come out due to the friction resistance of the wave-shaped member.

According to the present invention, in the multiple-glazing unit described above, the gap-maintaining member may comprise two divided hard portions to be inserted between the glass sheets, and a soft portion which connects the two divided hard portions, and which is softer than the hard portions; and the two divided hard portions are brought into contact with the glass surfaces of the glass sheets through resistive members.

When the hard part is divided into two hard portions, the two hard portions are connected by the soft portion, and the two hard portions are brought into contact with the glass surfaces of the glass sheets through the resistive members in the above-described way, if the two hard portions are pressed in a direction, in which they approach each other against the elastic force of the soft portion, and are then inserted, in this state, into the space, the restoring force of the soft portion acts on the two hard portions to press them against the glass surfaces. At that time, since the two hard portions are pressed against the glass surfaces through the resistive members, the hard portions do not come out from the space, reliably maintaining the gap between the glass sheets.

According to the present invention, in the multiple-glazing unit described above, the gap-maintaining member may be provided, at a face thereof close to the resin spacer, with a protrusion to be driven into the resin spacer.

When the protrusion is formed in the gap-maintaining member, and when the protrusion is driven into the resin spacer for inserting the gap-maintaining member, the gap-maintaining member can be prevented from coming out.

In a multiple-glazing unit according to the present invention, a gap-maintaining member may comprise a hard portion serving as a core, and a soft portion provided at a position where the hard portion faces a glass sheet, as described above. The hard portion and the soft portion may be integrally formed or may be separately formed. An example of their material is polyvinyl chloride.

The present invention also provides a method for manufacturing a multiple-glazing unit, which comprises the steps of placing a resin spacer formed in the shape of a string, around and in the vicinity of a peripheral edge of a first glass sheet; placing, on the first glass sheet with the resin spacer placed thereon, a second glass sheet, with the resin spacer being interposed therebetween; bonding the first glass sheet and the second glass sheet through the resin spacer by applying pressure, or by applying heat and pressure, to the resin spacer; and fitting and placing a gap-maintaining member for maintaining a gap between the glass sheets, at an outer peripheral portion of the resin spacer opposite the air space, such that the gap-maintaining member is flush with the peripheral edges of the glass sheets or closer to the air space than the peripheral edges.

This manufacturing method is characterized in that the resin spacer formed in the shape of a string is disposed around and in the vicinity of the peripheral edge of a glass sheet at room temperature; and pressure is applied, or heat and pressure are applied, to the resin spacer to be bonded with the glass sheet; and a gap-maintaining member for maintaining the gap between the glass sheets is disposed at an outer peripheral portion of the resin spacer opposite the air space. For a multiple-glazing unit that uses an aluminum spacer having a hollow structure in which a desiccant can be inserted, many manufacturing steps are required, such as an insertion step for inserting the desiccant into the hollow part of the aluminum spacer, a step for assembling and bending the aluminum spacer, a step for placing the aluminum spacer on a glass sheet, a pressure application step after two or more glass sheets are bonded together, a step for filling a sealant at an outer peripheral portion of the aluminum spacer, and a curing process before the sealant has been hardened. A large-scale facility, which includes a pressure machine and a sealant filling machine, is thus required.

For a multiple-glazing unit manufactured by placing a resin spacer on a glass sheet while an extrusion molding machine is used to extrude the resin spacer, there are needed an extruding machine for the resin spacer and equipment for maintaining a gap between two glass sheets in order to place the resin spacer therein while the resin spacer is being disposed. In contrast, in the method for manufacturing a multiple-glazing unit according to the present invention, a resin spacer wound in the shape of a reel is placed in the vicinity of a peripheral edge of a glass sheet, and pressure is applied, or heat and pressure are applied, to glass sheets, which have been put one on another. Since few steps are needed and since no large-scale facility is required, the multiple-glazing unit can be easily manufactured. To improve the adhesion between the resin spacer and the glass sheets, a primary coating, which contains a silane coupler and so forth, may be applied in the vicinity of the peripheral edges of the glass sheets before the resin spacer is placed.

### Effect of the Invention

According to the multiple-glazing unit of the present invention, the gap-maintaining member is fitted in the space formed in a concave shape in section by the inner surfaces of the peripheral portions of two facing glass sheets and the outer peripheral surface of the resin spacer, and the gap-maintaining member is placed flush with peripheral edges of the two glass sheets or closer to the air space than the peripheral edges. Therefore, the gap between the glass sheets can be reliably maintained without impairing the appearance of the multiple-glazing unit.

### BRIEF DESCRIPTION OF THE DRAWINGS

FIG. 1 is a cross-sectional view of an essential portion of the multiple-glazing unit according to a first embodiment;

FIG. 2 is a cross-sectional view of an essential portion of the multiple-glazing unit according to a second embodiment;

FIG. 3 is a cross-sectional view of an essential portion of the multiple-glazing unit according to a third embodiment;

FIG. 4 is a cross-sectional view of an essential portion of the multiple-glazing unit according to a fourth embodiment;

FIG. 5 is a cross-sectional view of an essential portion of the multiple-glazing unit according to a fifth embodiment;

FIG. 6 is a block diagram showing a method for manufacturing the multiple-glazing-unit according to the present invention;

FIG. 7 is a cross-sectional view of an essential portion of a conventional multiple-glazing unit, which uses a resin spacer;

FIG. 8 is a cross-sectional view showing an attachment member mounted to a multiple-glazing unit; and

FIG. 9 is a cross-sectional view showing how the attachment member shown in FIG. 8 is mounted to the multiple-glazing unit shown in FIG. 7.

### DESCRIPTION OF REFERENCE SYMBOLS

1: Glass sheets, 2: Thermoplastic resin spacer, 3: Spacer piece, 4: Protrusion, 5: Air space, 6: Attachment member, 7: Groove formed in a concave shape, 10: Multiple-glazing unit, 12: Glass sheets, 12A: Peripheral edge, 14: Air space, 16: Resin spacer, 18: Space, 20: Gap-maintaining member, 22: Hard portion, 24: Soft portion, 30: Gap-maintaining member, 32: Hard portion, 34: Soft portion, 36: Space, 40: Gap-maintaining member, 42: Hard portion, 44: Soft portion, 50: Gap-maintaining member, 52: Hard portion, 54: Soft portion, 56: Film (resistive member), 60: Gap-maintaining member, 62: Hard portion, 64: Protrusion, 100: Cleaning step, 110: Primary-coating application step, 12: Drying step, 130: Bonding step, 140: Glass-sheet bonding step, 150: Heating and roller pressing step, 160: Gap-maintaining member mounting step

### BEST MODE FOR CARRYING OUT THE INVENTION

Preferred embodiments of the double-glazing unit according to the present invention will be described below, referring to the accompanying drawings.

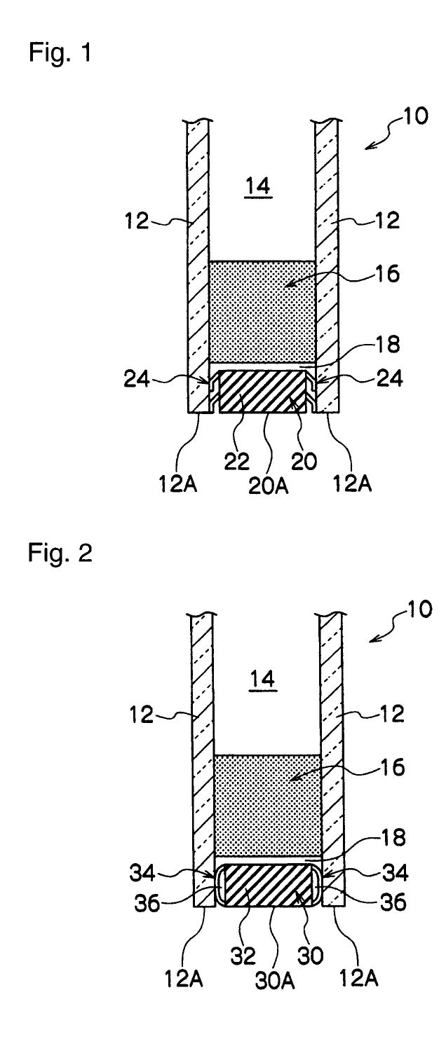

FIG. 1 is a cross-sectional view of an essential portion of the multiple-glazing unit 10 according to a first embodiment. In the multiple-glazing unit 10, two glass sheets 12 are spaced from each other with a resin spacer 16 provided therebetween in order to form an air space 14 therebetween. The resin spacer 16 is a self-adhesive elastomer spacer into which a desiccant has been kneaded. It is preferred that the resin spacer contain, as a matrix component, at least one type of butyl elastomer component selected from the group consisting of polyisobutylene, butyl rubber, and modified butyl rubber; that the molecular weight index (MWI) of the butyl elastomer component, represented by the following expression (1), be at least 400,000; and that the elastomer spacer contain no crystalline polyolefin:

$$MWI = {\sum }_{i} ( ( Mw ( i ) ⨯ ( ( mass percent of the i \text{-} th butyl$$

elastomer component in the total amount of all butyl
elastomer components)/100)) (1)

(wherein “i” is an integer equal to “1” or more representing the number of types of butyl elastomer components contained, as a matrix component, in the elastomer spacer, and Mw(i) indicates the viscosity-average average molecular weight of the i-th butyl elastomer component.)

The elastomer spacer contains less than 2 mass-percent percent of crystalline polyolefin. The elastomer spacer also contains, as filler components, a desiccant and at least one member selected from the group consisting of carbon black, coloring pigment, and inorganic fillers, and the filler components are contained in the elastomer spacer at 40 to 75 mass-percent in total. The elastomer spacer has a melt volume rate (MVR) of 0.1 cm³/sec or less when the rate is measured according to JIS K7210 (1999) by using a Koka flow tester at 150° C. under a load of 55 kgf (539 N), a die length (L) of 5 mm, and a die diameter (D) of 1 mm. When the material of the resin spacer 16 is specified in this way, the creeping property of the spacer material is reduced, allowing the multiple-glazing unit 10 to have an excellent shape holding property. The resin spacer also achieves good contact with the glass sheets 12, and the spacer material has a low humidity permeability, allowing the multiple-glazing unit 10 to have an excellent durability.

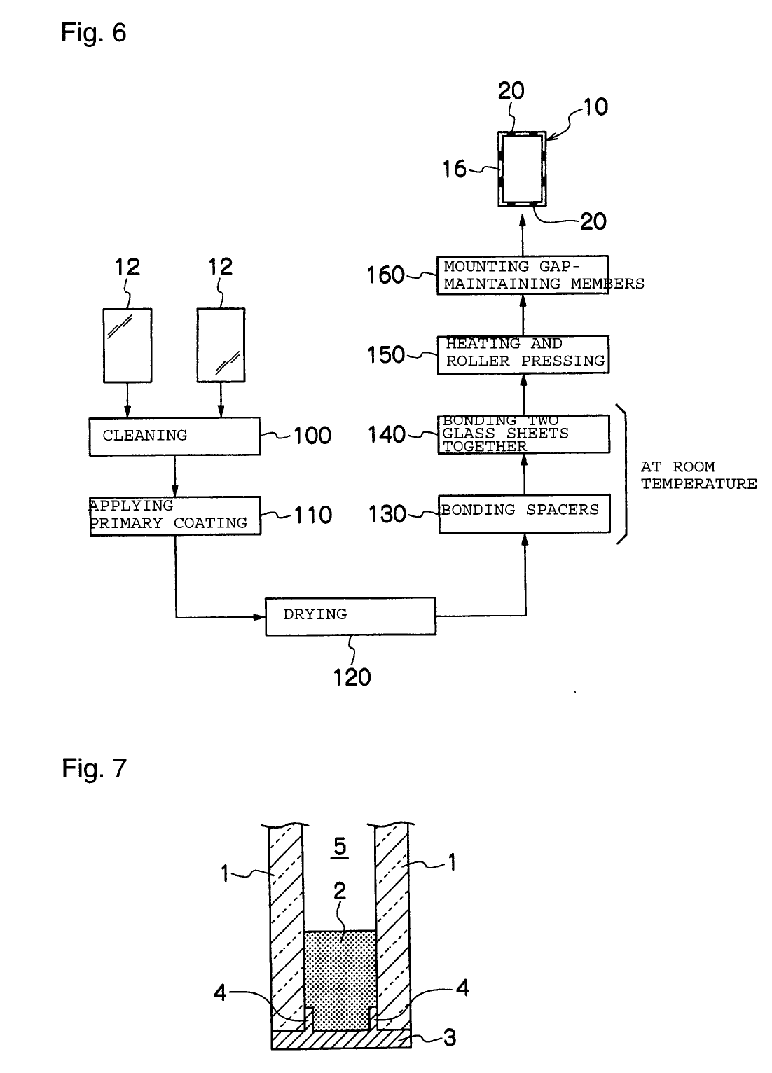

In the multiple-glazing unit according to the present invention, it is preferred that the elastomer spacer have a height of 6 to 7 mm (in a vertical direction of the resin spacer 16 shown in FIG. 1) in consideration of ease of reel winding after extrusion and ease of bending at corners when bonded to the glass. When it is assumed that a spacer for general multiple-glazing units has a height of 10 mm, it is preferred that a gap-maintaining member 20 have a height of 2 to 3 mm. With these settings, the total height of the resin spacer 16 and the gap-maintaining member 20 is equal to or close to the height of the spacer for general multiple-glazing units. In other words, it is characterized in that around the entire peripheral portion, or a part thereof, of the two glass sheets of the multiple-glazing unit, there is a portion having a height of 2 to 3 mm (vertically in FIG. 6) from an end of the glass between the glass sheets, where the elastomer spacer (resin spacer 16) is not provided; the gap-maintaining member is disposed there so as not to protrude from the end; and that the elastomer spacer is provided within a height of 10 mm from the end of the glass between the two glass sheets of the multiple-glazing unit.

In the multiple-glazing unit 10, the gap-maintaining member 20, which maintains the gap between the two glass sheets 12, is fitted in a space 18 formed in a concave shape in section by an outer peripheral surface of the resin spacer 16 and the inner surfaces of peripheral portions of the two facing glass sheets 12. The gap-maintaining member 20 is disposed such that its outer side face 20A is flush with the peripheral edges 12A of the two glass sheets 12, or such that its outer side face 20A is slightly closer to the air space 14 than the peripheral edges.

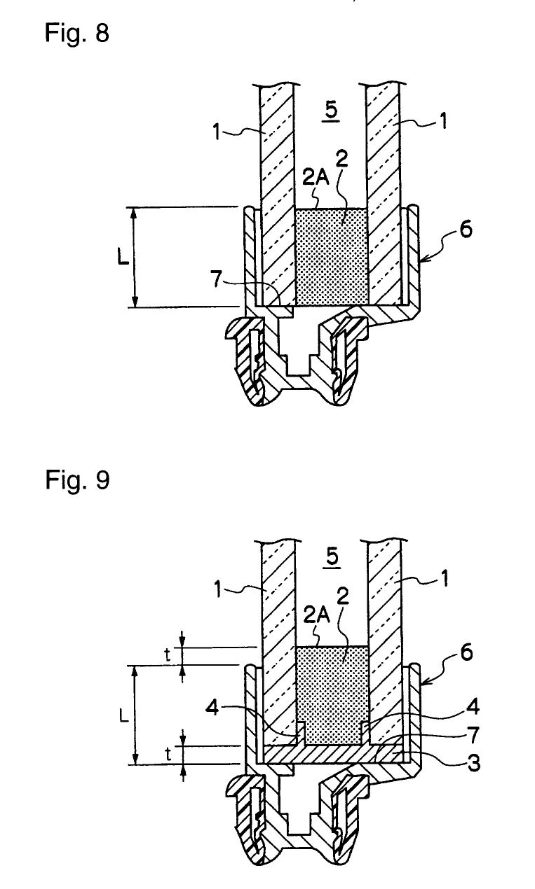

With this arrangement, according to the multiple-glazing unit 10 of the first embodiment, since the resin spacer 16 does not protrude from an attachment member 6 (see FIG. 8 and FIG. 9), the appearance of the multiple-glazing unit 10 is not impaired. In addition, since the double-glazing unit is configured such that the gap-maintaining member 20 is fitted in the space 18 formed in a concave shape in section, the gap between the glass sheets 12 can be reliably maintained, compared with multiple-glazing units, such as that described in patent document 2, where a spacer piece easily comes off to fail to maintain the gap between the glass sheets. The gap-maintaining member 20 does not need to be disposed around the entire peripheral portion of the multiple-glazing unit 10. For example, the gap-maintaining member may comprise plural members formed in a block shape having a length of several cm, and the respective members may be disposed at predetermined intervals or at predetermined positions to maintain the gap between the glass sheets 12.

The gap-maintaining member 20 comprises a hard portion 22 formed in a rectangular shape in section so as to be inserted in the space between the glass sheets 12, and soft portions 24 which are provided on the hard portion 22 at locations where the hard portion 22 faces the glass sheets 12, which are brought into close contact with the inner surfaces of the peripheral portions of the glass sheets 12, and which are softer than the hard portion 22. It is preferred, for example, that “hard” indicate 90 or more and “soft” indicate 60 to 80 in the duro-hardness scale specified in JIS K6253 (1993).

These soft portions 24 are fin-shaped members tilted at an acute angle with respect to a direction in which the hard portion 22 is inserted into the space 18, as shown in FIG. 1. Two soft portions 24 are formed at each side of the hard portion 22.

With the soft portions 24 formed in this way, the soft portions 24 tend to offer no resistance when the hard portion 22 is inserted into the space 18. Therefore, the insertion is easy. After insertion, since the fin-shaped soft portions 24 serve as so-called barbs, the hard portion 22 does not come out from the space 18.

Consequently, with the use of this gap-maintaining member 20, the gap between the glass sheets 12 can be reliably maintained. The hard portion 22 and the soft portions 24 may be made of polyvinyl chloride. They may be integrally formed or may be separately formed.

A gap-maintaining member 30 for the multiple-glazing unit 10 according to a second embodiment, shown in FIG. 2, comprises a hard portion 32 serving as a core, and soft portions 34, the hard portion 32 having the same structure as the hard portion 22 shown in FIG. 1. The soft portions 34 comprise dome-shaped members having apexes at points where they are brought into contact with the glass surfaces of glass sheets 12. The soft portions 34 and the hard portion 32 have spaces 36 formed therebetween to give the soft portions 34 elasticity. The spaces 36 may be provided inside the dome-shaped members.

According to the gap-maintaining member 30 structured in this way, the hard portion 32 can be easily pressed into the space 18 to be inserted between the glass sheets 12. After insertion, since the soft portions 34 and the glass sheets 12 are brought into surface contact to generate a large friction resistance due to the air pressure in the spaces 36, the hard portion 32 does not come out from the space 18. In the gap-maintaining member 30, its outer side face 30A (actually, an outer side face of the hard portion 32) is disposed flush with the peripheral edges 12A of the two glass sheets 12, or is slightly closer to an air space 14 than the peripheral edges, in the same way as in the gap-maintaining member 20.

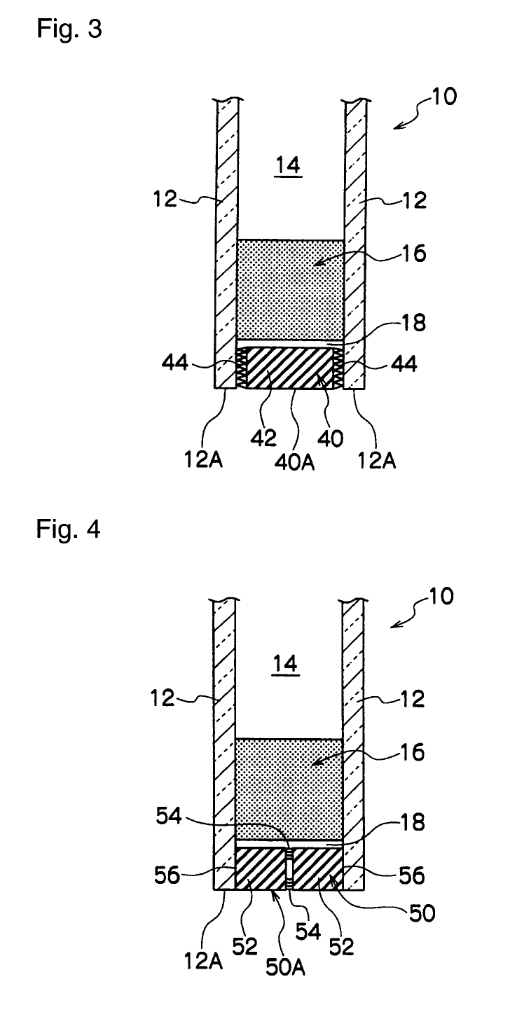

A gap-maintaining member 40 for the multiple-glazing unit 10 according to a third embodiment, shown in FIG. 3, comprise a hard portion 42 serving as a core, and soft portions 44, the hard portion 42 having the same structure as the hard portion 22 shown in FIG. 1. The soft portions 44 are formed in a wave shape. Since the soft portions comprise wave-shaped members, when the hard portion 42 is inserted into a space 18, the soft portions 44 are pressed against the glass surfaces of glass sheets 12 to be deformed elastically, allowing the hard portion 42 to be pressed in. After insertion, the soft portions 44 are brought into close contact with the glass sheets 12 due to the restoring force of the soft portions 44 to generate a large friction resistance, and therefore, the hard portion 42 does not come out from the space 18. In the gap-maintaining member 40, its outer side face 40A (actually, an outer side face of the hard portion 42) is disposed flush with the peripheral edges 12A of the two glass sheets 12, or is slightly closer to an air space 14 than the peripheral edges, in the same way as in the gap-maintaining member 20.

A gap-maintaining member 50 for the multiple-glazing unit 10 according to a fourth embodiment, shown in FIG. 4, comprise two divided hard portions 52 serving as cores. A soft portion 54 adheres to facing surfaces of the hard portions 52 so as to connect the two divided hard portions 52. On outer side faces of the hard portions 52, where the hard portions 52 are brought into contact with glass sheets 12, films (resistor members) 56 having a rough surface are bonded so as to generate a large friction force between the glass sheets 12 and the hard portions 52.

According to this gap-maintaining member 50, the two divided hard portions 52 are pressed together in a direction in which they approach each other, against the elastic force of the soft portion 54, and are inserted into the space 18. Then, the restoring force of the soft portion 54 acts on the hard portions 52 to press the side faces thereof against glass sheets 12. At that time, since the side faces of the hard portions 52 are pressed against the glass sheets 12 through the films 56, in other words, since a large friction force is given in the direction in which the hard portions 52 come out, the hard portions 52 do not come out from the space 18. Therefore, the gap between the glass sheets 12 can be reliably maintained. In the gap-maintaining member 50, its outer side face 50A (actually, outer side faces of the hard portions 52) is disposed flush with the peripheral edges 12A of the two glass sheets 12, or is slightly closer to an air space 14 than the peripheral edges. Instead of the films 56, the fin-shaped soft portions 24 shown in FIG. 1, the dome-shaped soft portions 34 shown in FIG. 2, or the wave-shaped soft portions 44 shown in FIG. 3 may be used.

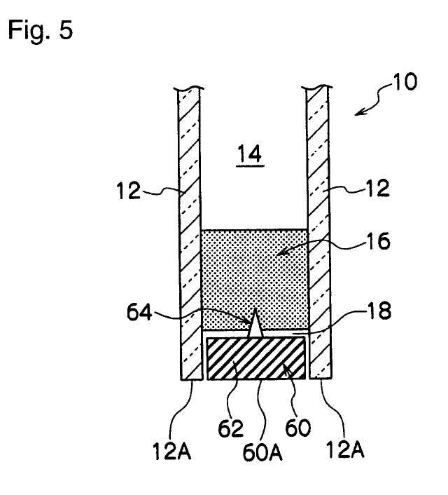

A gap-maintaining member 60 for the multiple-glazing unit 10 according to a fifth embodiment, shown in FIG. 5, has a hard portion 62 serving as a core, and the hard portion 62 is provided, at an inner side face, with a sharp-pointed protrusion 64 to be driven into a resin spacer 16. A barb (not shown) is formed at the tip of the protrusion 64 to prevent the protrusion 64 driven in the resin spacer 16 from coming out. This gap-maintaining member 60 can also be easily inserted into a space 18. By driving the protrusion 64 in the resin spacer 16 the gap-maintaining member 60 is reliably prevented from coming out. The protrusion 64 may be provided on the hard portions 22, 32, 42, and 52 shown in FIG. 1 to FIG. 4. The fin-shaped soft portions 24 shown in FIG. 1, the dome-shaped soft portions 34 shown in FIG. 2, or the wave-shaped soft portions 44 shown in FIG. 3 may be formed at side faces of the hard portion 62.

FIG. 6 shows respective steps illustrating a preferred method for manufacturing the multiple-glazing unit 10. Two glass sheets 12 constituting the multiple-glazing unit 10 are first cleaned in a cleaning step 100, and then primary coating is applied to peripheral portions of the glass sheets 12, where the resin spacer 16 is bonded, in a primary-coating application step 110. Next, the glass sheets 12 are dried in a drying step 120, and then transferred to a bonding step 130 for the resin spacer 16.

In the bonding process 130 a string-shaped resin spacer 16, which is wound in the shape of a reel is rewound at room temperature (at normal temperature), being placed around and in the vicinity of the peripheral edge of one (a first) of the glass sheets 12. Next, in a process for bonding two glass sheet 140, the other (a second) of the glass sheets 12 is put on the first one of the glass sheets 12 on which the resin spacer 16 has been placed, with the resin spacer 16 disposed therebetween, and the two glass sheets are bonded together. Then, in a heating and roller-pressing process 150, the resin spacer 16 is heated by a heater, and a roller applies pressure to the two glass sheets 12 placed one on another to bond the two glass sheets 12 with the resin spacer 16. Depending on the material of the resin spacer, the two glass sheets 12 may be bonded merely by using the roller to apply pressure to the two glass sheets 12, without heating them.

Next, the two bonded glass sheets 12 are transferred to a gap-maintaining member mounting process 160. At the outer peripheral portion of the resin space 16 opposite the air space 14, the gap-maintaining members 20 shown in FIG. 1, for example, are fitted and placed such that the gap-maintaining members are flush with the peripheral edges 12A of the glass sheets 12 or closer to the air space 14. The multiple-glazing unit 10 is thus manufactured in this way.

The manufacturing method shown in FIG. 6 is characterized in that the resin spacer 16 formed in the shape of a string is placed around and in the vicinity of the peripheral edges of the glass sheets 12 at room temperature. More specifically, it is characterized by using the hardened resin spacer 16 to manufacture the multiple-glazing unit, which is different from a manufacturing method in which a resin spacer 16 is extruded by an extrusion molding machine and placed on a glass sheet 12.

With the use of this manufacturing method of the present invention, a resin spacer 16 wound in the shape of a reel only need to be delivered to a manufacturing plant, and the manufacturing plant does not need to have a large-scale pressure machine, a sealant filling machine, or an extrusion molding machine, allowing the multiple-glazing unit 10 to be manufactured by a simple facility.

Although explanation of the above embodiments has been made about a case where the multiple-glazing unit is formed of two glass sheets 12, the number of glass sheets 12 is not limited to two. A similar gap-maintaining member may be used to a double-glazing unit that is formed of three or more glass sheets.

### INDUSTRIAL APPLICABILITY

In the multiple-glazing unit according to the present invention, the gap-maintaining member is fitted into and placed in the portion 7 formed in a concave shape by the inner surfaces of the peripheral portions of two facing glass sheets and the outer peripheral surface of the resin spacer, such that the gap-maintaining member does not protrude from the peripheral edges of the two glass sheets. Therefore, the appearance of the multiple-glazing unit is not impaired, and the gap between the glass sheets can be reliably maintained, so that the multiple-glazing unit can be used as glass for buildings and vehicles.

The entire contents of the specification, claims, drawings, and abstract of Japanese Patent Application No. 2004-341875, filed on Nov. 26, 2004, are cited here and incorporated herein by reference as the disclosure of the specification of the present invention.

What is claimed is:

1. A multiple-glazing unit in which a resin spacer is placed close to peripheral edges of at least two facing glass sheets to separate the glass sheets with a gap therebetween to form an air space therebetween,
wherein a gap-maintaining member for maintaining the gap between the two glass sheets is fitted in a space formed in a concave shape in section by inner surfaces of peripheral portions of the two facing glass sheets and an outer peripheral surface of the resin spacer, and the gap-maintaining member is placed flush with the peripheral edges of the two glass sheets or closer to the air space side than the peripheral edges.

2. The multiple-glazing unit according to claim 1, wherein the gap-maintaining member comprises a hard portion to be inserted into the space between the glass sheets, and a soft portion, which is provided on the hard portion, which is brought into close contact glass surfaces of the glass sheets, and which is softer than the hard portion.

3. The multiple-glazing unit according to claim 2, wherein the soft portion comprises a fin-shaped member tilted at an acute angle with respect to an insertion direction of the hard portion.

4. The multiple-glazing unit according to claim 2, wherein the soft portion comprises a dome-shaped member having an apex at a position where the dome-shaped member is brought into contact with a glass surface of the glass sheets, and a space is formed between the dome-shaped member and the hard portion, or within the dome-shaped member.

5. The multiple-glazing unit according to claim 2, wherein the soft portion comprises a wave-shaped member.

6. The multiple-glazing unit according to claim 1, wherein the gap-maintaining member comprises two divided hard portions to be inserted between the glass sheets, and a soft portion, which connects the two divided hard portions, and which is softer than the hard portions; and the two divided hard portions are brought into contact with the glass surfaces of the glass sheets through resistive members.

7. The multiple-glazing unit according to claim 1, wherein the gap-maintaining member is provided, at a face thereof close to the resin spacer, with a protrusion to be driven into the resin spacer.

8. A method for manufacturing a multiple-glazing unit, comprising the steps of:
placing a resin spacer formed in the shape of a string, around and in the vicinity of a peripheral edge of a first glass sheet;
placing, on the first glass sheet with the resin spacer placed thereon, a second glass sheet, with the resin spacer being interposed therebetween;
bonding the first glass sheet and the second glass sheet through the resin spacer by applying pressure, or by applying heat and pressure, to the resin spacer; and
fitting and placing a gap-maintaining member for maintaining a gap between the glass sheets, at an outer peripheral portion of the resin spacer opposite the air space, such that the gap-maintaining member is placed flush with the peripheral edges of the glass sheets or closer to the air space than the peripheral edges.
